(19) United States
(12) Patent Application Publication
(10) Pub. No.: US 2004/0252429 A1
(43) Pub. Date: Dec. 16, 2004

(54) Line arrangement for electrical systems of vehicles

(75) Inventors: Jean-Marc Karl Edgard Maurice Virgin, Koeln (DE); Joerg Ehrhardt, Nuertingen (DE)

Correspondence Address: LAW OFFICE OF BARRY R LIPSITZ, 755 MAIN STREET, MONROE, CT, 06468, US

(73) Assignee: Alcoa Fujikura Gesellschaft mit beschraenkter Haftung, Frickenhausen (DE)

(21) Appl. No.: 10/626,834

(22) Filed: Jul. 21, 2003

(30) Foreign Application Priority Data
Jul. 23, 2002 (DE) 102 34 389.6

(51) Int. Cl. H02H 3/00

(52) U.S. Cl. 361/62

(57) ABSTRACT

In order to improve a line arrangement for electrical systems of vehicles, comprising an electrical supply line running from a current feed terminal to a current delivery terminal and having at least one current-carrying inner conductor and at least one protective sheath surrounding the latter in such a way that, when an arc forms, remedial action can be rapidly taken, it is proposed that a detector element which runs along the supply line and is formed in such a way that its electrical and/or optical behavior is irreversibly changed when a local arc originating from the current-carrying inner conductor occurs is provided, and that an isolating circuit which is connected to the current feed terminal and isolates the current-carrying inner conductor from a current source when the electrical and/or optical behavior of the detector element changes is provided.

The present disclosure relates to the subject matter disclosed in German application No. 102 34 389.6 of Jul. 23, 2002, which is incorporated herein by reference in its entirety and for all purposes.

The invention relates to a line arrangement for electrical systems of vehicles, comprising an electrical supply line running from a current feed terminal to a current delivery terminal and having at least one current-carrying inner conductor and at least one protective sheath surrounding the latter.

Line arrangements of this type are known from vehicle technology.

If the electrical supply line is operated with voltages that are above 12 volts, preferably above 20 volts, there is a latent potential for a dangerous situation to arise if the inner conductor has a defect or if the protective sheath is damaged, since in each case an arc can then form by way of the defect of the inner conductor or, originating from the inner conductor, to any part of the vehicle, in particular to a grounded part of the vehicle, and this represents a considerable risk of fire.

It is therefore an object of the invention to improve the line arrangement of the generic type in such a way that, when an arc forms, remedial action can be rapidly taken.

This object is achieved in the case of a line arrangement of the type described at the beginning according to the invention by providing a detector element which runs along the supply line and is formed in such a way that its electrical and/or optical behavior is irreversibly changed when a local arc originating from the current-carrying inner conductor occurs, and by providing an isolating circuit which is connected to the current feed terminal and isolates the current-carrying inner conductor from a current source when the electrical and/or optical behavior of the detector element changes.

The advantage of the solution according to the invention is to be seen in that it creates the possibility of detecting an arc originating from the current-carrying inner conductor immediately after it occurs and of taking remedial action by the current-carrying inner conductor being isolated from the current source, so that the arc is immediately extinguished and no further damage can be caused by the arc.

Furthermore, the arrangement also offers mechanical protection from direct contact between the spatially enclosed interior supply line with a voltage of greater than 20 volts and other potentials spatially outside the line arrangement. This greatly reduces the probability of a short-circuit between the spatially interior supply line and the spatially exterior potentials. As a result, it is possible for example for exterior systems with lower voltage to be protected from the effects of an increase in potential through the supply line.

With regard to the changing of the behavior of the detector element when the arc occurs, a wide variety of possibilities are conceivable. According to the invention, it is merely required that a significant irreversible change of the electrical and/or optical behavior occurs. For example, it could be the case that the electrical and/or optical properties improve under the local effect of the arc.

It is particularly advantageous if the detector element irreversibly deteriorates in its electrical and/or optical behavior under the local effect of heat. This allows the detector element to be formed in a particularly simple and suitable manner.

In particular, the detector element can be formed in a particularly simple and suitable manner if, under the local effect of heat, it irreversibly deteriorates in its capability of allowing electrical and/or optical signals to pass through it.

In principle, it would be conceivable to form the detector element in such a way that it also responds to a remote effect of an arc with a change of its electrical and/or optical behavior.

In order to ensure that the detector element senses an arc forming in every case, it is preferably provided that the detector element surrounds the supply line.

With regard to the formation of the detector element, a wide variety of solutions are conceivable.

For example, it would be conceivable to form the detector element from a flat piece of material, the electrical and/or optical properties of which are changed when an arc occurs.

However, a particularly advantageous solution is one in which the detector element comprises at least one electrical and/or optical line as a detector line, the electrical and/or optical behavior of which is irreversibly changed when the arc occurs.

An advantageous exemplary embodiment of the detector line according to the invention in this case provides that the detector line runs in the form of a helix.

Another alternative solution in this respect provides that the detector line runs in the form of meanders, the meanders then preferably lying in a surface area that encloses the supply line at least partially, still better encloses it substantially.

Apart from the detector line being formed as a helix or as meanders, however, other possibilities are also conceivable. For example, it would be conceivable to form the detector line in the form of a netting or woven fabric.

To be able to detect as extensively as possible an arc occurring on the supply line, it is preferably provided that portions of the detector line following one another in the longitudinal direction of the supply line and running transversely in relation to a longitudinal direction of the supply line are spaced apart from one another by a spacing which is less than twice the diameter of the inner conductor.

With this solution it is ensured that, when an arc forms, it is highly probable that at least one such portion of the detector line lies in the region through which the arc passes.

With regard to the formation of the detector line, a wide variety of possibilities are likewise conceivable. For example, it would be conceivable to produce the detector line from a material which changes in its electrical and/or optical behavior on the basis of the radiation produced when there is an arc.

It is particularly advantageous, however, if the detector line consists of a material which irreversibly changes in an electrical and/or optical behavior when there is local ingress of an amount of heat generated by the arc. That is to say that the heat produced by the arc is the cause of the irreversible change of the electrical and/or optical behavior.

In order on the one hand to be sure that the detector line does not already change in its electrical and/or optical behavior under normal operating conditions of a vehicle and the corresponding temperatures, but responds as quickly as possible to an arc forming, it is preferably provided that the detector line consists of a material which irreversibly changes in an electrical and/or optical behavior already from a threshold temperature, which lies in the range from approximately 100° C. to approximately 500° C.

In order to protect the detector line, it is preferably provided that it is surrounded by an insulating protective enclosure.

With regard to the construction of the detector element with the detector line, a wide variety of possibilities are conceivable. A particularly advantageous solution provides that the detector element has a carrier, on or in which the detector line is held.

This solution is intended in particular for cases in which the detector line is formed in a way similar to a wire or fiber.

Another preferred solution provides that the detector line is disposed in the form of conducting tracks on a carrier.

In this case, it is preferably provided that the detector line is applied to the carrier in the form of a printing or coating process and consequently the integrity of the carrier is necessary in order to maintain the integrity of the detector line.

For example, the detector line may be, preferably, a vapor-deposited metallization or an applied conducting material, for example in powder form, or an applied material conducting optical signals.

The carrier may in this case be formed for example as a hose-like enclosure; which encloses the supply line, or as an element enclosing the supply line for example in a cross-sectionally C-shaped manner.

Another advantageous solution envisages forming the carrier as a carrier strip which helically encloses the supply line.

In order to be able to detect an arc occurring in every case, it is preferably provided that the carrier surrounds the supply line at least partially.

When a number of carrier strips are provided, it is conceivable that each carrier strip partially surrounds the supply line; the total of all the carrier strips completely encloses the supply line.

This can be realized for example by two carrier strips that are lying next to each other being wound around the supply line helically in with the same winding direction.

An alternative solution in this respect provides that two carrier strips are wound around the supply line helically in a crosswise manner, that is to say with opposite winding directions, and consequently cover each other at certain points.

It is preferably provided that the carrier encloses the supply line substantially completely.

In order to protect the detector line, it is preferably provided that the carrier forms part of a protective enclosure for the detector line.

The carrier may in this case consist of a wide variety of materials.

For example, the carrier is a material that is as resistant as possible to thermal or other effects.

The carrier may also be used, however, to contribute to the changing of the electrical and/or optical behavior of the detector element.

Consequently, an advantageous exemplary embodiment provides that the carrier is of a material which irreversibly changes under the local effect of the arc originating from the inner conductor.

The changes may in this case be any desired, for example the material may be chosen such that the carrier changes at least in some of its mechanical properties.

Another advantageous solution provides that the carrier consists of a material which irreversibly deforms under the effect of the arc originating from the inner conductor.

That is to say that this solution provides an active behavior of the carrier which at the same time also has an effect on the detector line, in the sense that the change in shape of the carrier causes it to change in its electrical and/or optical behavior.

A further advantageous embodiment of a carrier responding to the formation of an arc provides that the carrier consists of a material which irreversibly decomposes under the effect of the arc originating from the inner conductor.

A further advantageous solution provides that, on account of its irreversible change under the local effect of the arc, the carrier irreversibly impairs the electrical and/or optical behavior of the detector line.

Such an irreversible impairment of the detector line is already possible by the changing of the carrier leading to mechanical forces acting on the detector line which change the electrical and/or optical behavior of the detector line.

For example, in the case of an optical detector line, these could be mechanical stresses which influence the optical behavior of an optical conductor.

However, the simplest solution is that, on account of its irreversible change, the carrier locally interrupts the detector line. This can be realized in particular whenever, on account of the local effect of the arc, the carrier either loses its integrity and stability, and as a result no longer acts as a mechanical stabilizer for the detector line, so that the detector line itself becomes unstable and is interrupted, or releases great mechanical forces, which then act on the detector line and interrupt it.

In connection with the explanation so far of the individual exemplary embodiments it has only been discussed that the detector element irreversibly changes in its electrical and/or optical behavior when the arc occurs.

In order also to be able to establish when there is mechanical damage to the line arrangement by means of the same detector element, it is preferably provided that the detector element irreversibly changes in its electrical and/or optical behavior when it is mechanically damaged.

A particularly advantageous exemplary embodiment provides that the detector element changes in its electrical and/or optical behavior when it undergoes mechanical damage caused by a mechanical component at a potential other than that of the detector line.

This is of significance in particular when the line arrangement is used in motor vehicles, since in these the mechanical parts connected to the body are all grounded and consequently, when the detector element is damaged by such a part, it is highly probable that an arc can occur between the inner conductor and this grounded part, at least if the damage continues.

The fact that such a component which is at a potential other than that of the detector line can be detected by the detector supply element consequently creates the possibility of already isolating the supply line from the current source at least partially before the formation of an arc, and consequently avoiding the dangers caused by an arc from the outset.

For the case in which the detector element is provided with a detector line, it is preferably provided that the detector line also irreversibly changes in its electrical and/or optical behavior when the detector element undergoes mechanical damage.

This can be realized particularly advantageously if, when it undergoes mechanical damage, the detector line irreversibly deteriorates in its behavior with regard to the passing through of electrical and/or optical signals.

With regard to the embodiments of a detector element which responds to a component at a potential other than that of the detector line, no further details have been specified so far. Consequently, it is preferably provided that the detector line lies in a circuit specific to the detector line, so that it can be sensed if the detector line is touched by a mechanical component at a potential other than that of the detector line, since the circuit specific to the detector line is disturbed by this.

To be able to evaluate advantageously the various states sensed by the detector element, preferably at least one detector circuit which activates the isolating circuit is provided.

The detector circuit in this case preferably operates in such a way that it constantly checks the electrical and/or optical behavior of the detector element, in particular of the detector line of the same, and activates the isolating circuit in such a way that it isolates the supply line from the power supply if there is an irreversible change of this behavior.

In principle, the detector circuit can in this case be provided at any desired points of the line arrangement, as long as communication with the isolating circuit is ensured.

An advantageous solution envisages that the at least one detector circuit is associated with the current feed terminal, since this allows communication with the isolating circuit to be realized in a simple way.

It is also conceivable, however, for the at least one detector circuit to be associated with the current delivery terminal.

A further advantageous solution envisages that a number of detector circuits which communicate with one another are provided. In the case of a number of detector circuits, it is possible to check a line arrangement not just at one point but at a number of points.

The detector circuits may in this case communicate with one another and also with the isolating circuit in a wide variety of ways.

For example, it is conceivable that the at least one detector circuit communicates with the isolating circuit by means of an electrical line.

An alternative solution provides that the at least one detector circuit communicates with the isolating circuit by means of a light guide.

In the case of the provision of a number of detector circuits, it would be conceivable in principle that each of the number of circuits is in connection with the isolating circuit and can give the isolating circuit a signal for isolating the supply line from the current source. That is to say that in this case each of the detector circuits operates independently of the others.

It is particularly advantageous, however, if a number of detector circuits are provided and if the detector circuits communicate with one another to sense a change of the electrical and/or optical behavior of the detector element. That is to say that in this case the detector circuits do not operate independently of one another but in the manner of a network and that each of the detector circuits does not check the electrical and/or optical behavior of the detector element independently of the other detector circuit but instead the checking takes place by communication between at least two detector circuits.

For example, such a communication may take place by one detector circuit sending a signal which the other detector circuit receives.

Depending on whether or not the signal has arrived, the other detector circuit can consequently detect whether the detector element has changed with regard to its electrical and/or optical behavior.

In this case, the detector element can either enter into interaction directly with the isolating circuit or with the detector circuit which has sent the signal, and for example send a confirmation signal back again to this detector circuit, or not send back a confirmation signal, so that the detector circuit sending in the first instance then communicates with the isolating circuit on the basis of this check-back signal.

The communication of the detector circuits may in this respect be realized in a variety of ways. For instance, one advantageous solution provides that the detector circuits communicate with one another via an internal line within the line strand.

This internal line within the line strand may either be a separate line, provided in the line strand, for the communication of the detector circuits with one another, or the detector element, in particular the detector line of the same, may be used directly for allowing the detector circuits to communicate with one another.

As an alternative to this, however, it is also possible for the detector circuits to communicate with one another via an external line outside the line strand.

Such an external line outside the line strand may be an additional separate line, but such an external line outside the line strand may also be a customary electrical or optical data bus line, as are present in any case in modern motor vehicles.

In particular, the detector circuits may in this case communicate with one another either via an electrical line or via an optical line.

It is also possible, however, for the detector circuits to communicate with one another in one direction via an electrical line, namely in another direction via an optical line.

In the case of an advantageous exemplary embodiment, there is even the possibility of providing both an optical line and an electrical line in the form of a detector line in the line strand, with the result not only that the two detector lines permit the communication of the detector circuits, but that it is also possible to check at the same time by communication via these detector lines the extent to which their electrical and/or optical behavior changes.

In order also to be able to sense the effect on the detector element of components with potentials other than that of the detector line, it is preferably provided that the detector circuit detects the occurrence of a potential in the detector line other than that of the detector line and, after detecting the same, activates the isolating circuit in such a way that it isolates the supply line from the current source.

There is consequently the possibility of sensing an electrically conducting connection with the inner conductor or else all the external potentials other than those of the detector line and supply line, detecting this as a defective state and isolating the inner conductor from the current source. For example, there is the possibility of spatially separating two voltage networks by the detector element. An electrical contact between the detector element and an outside voltage network results in disconnection of at least one of the voltage networks.

Further features and advantages of the invention are the subject of the following description and the graphic representation of some exemplary embodiments.

In the drawing:

FIG. 1 shows a schematic representation of a first exemplary embodiment of a solution according to the invention in the case of a first case of a defect;

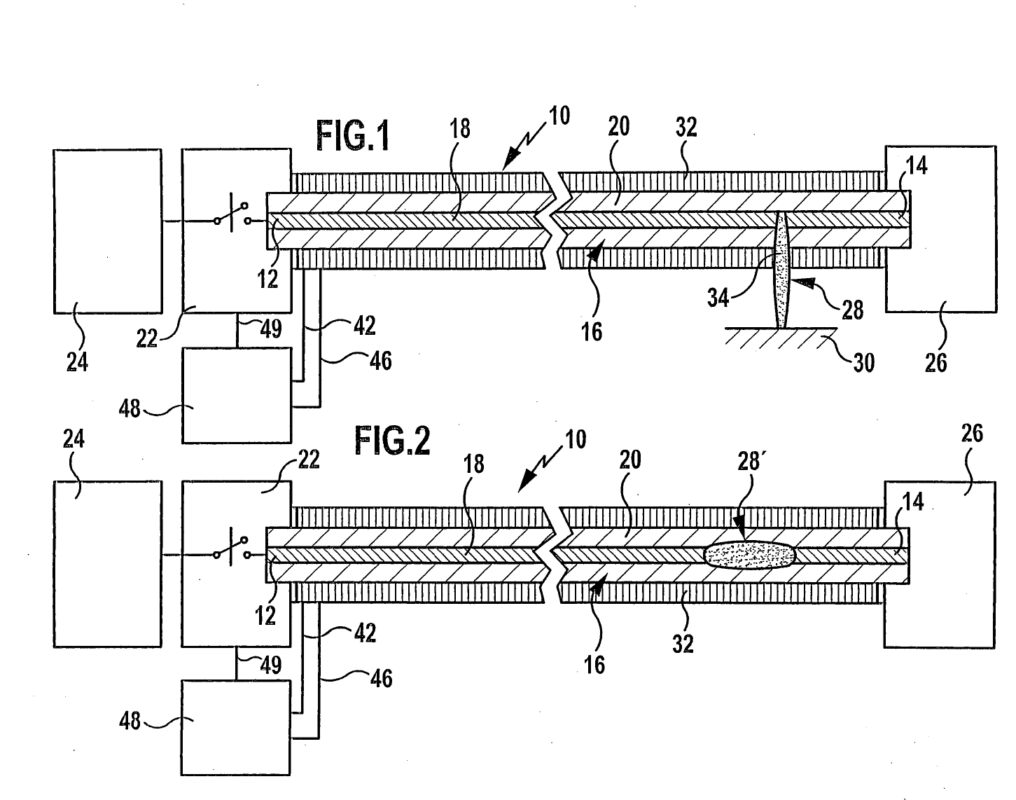

FIG. 2 shows a schematic representation of a first exemplary embodiment of the solution according to the invention in the case of a second case of a defect;

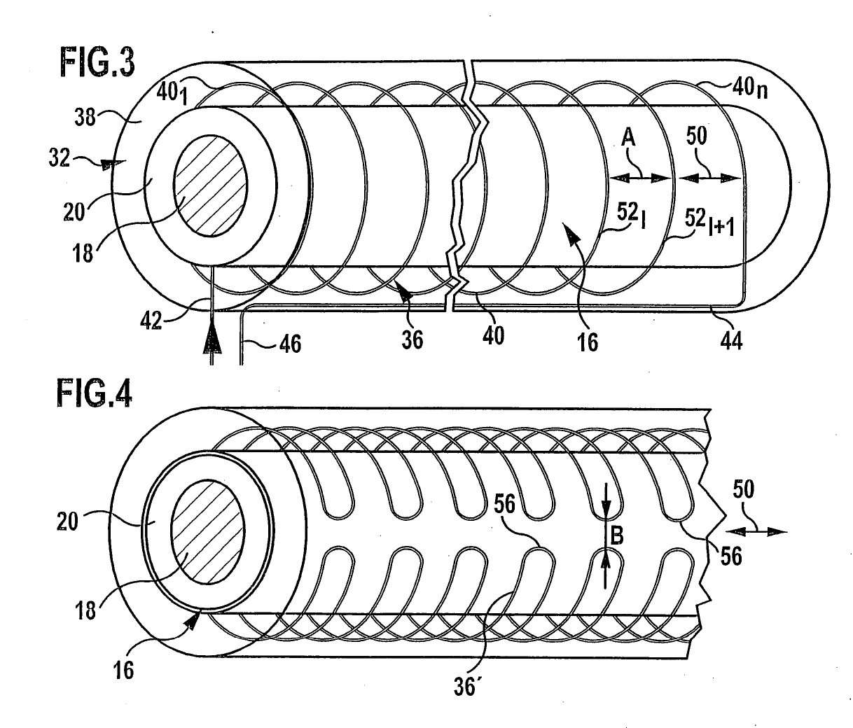

FIG. 3 shows an enlarged representation in extract form of a portion of the line arrangement in the case of the first exemplary embodiment;

FIG. 4 shows a representation similar to FIG. 3 of a second exemplary embodiment;

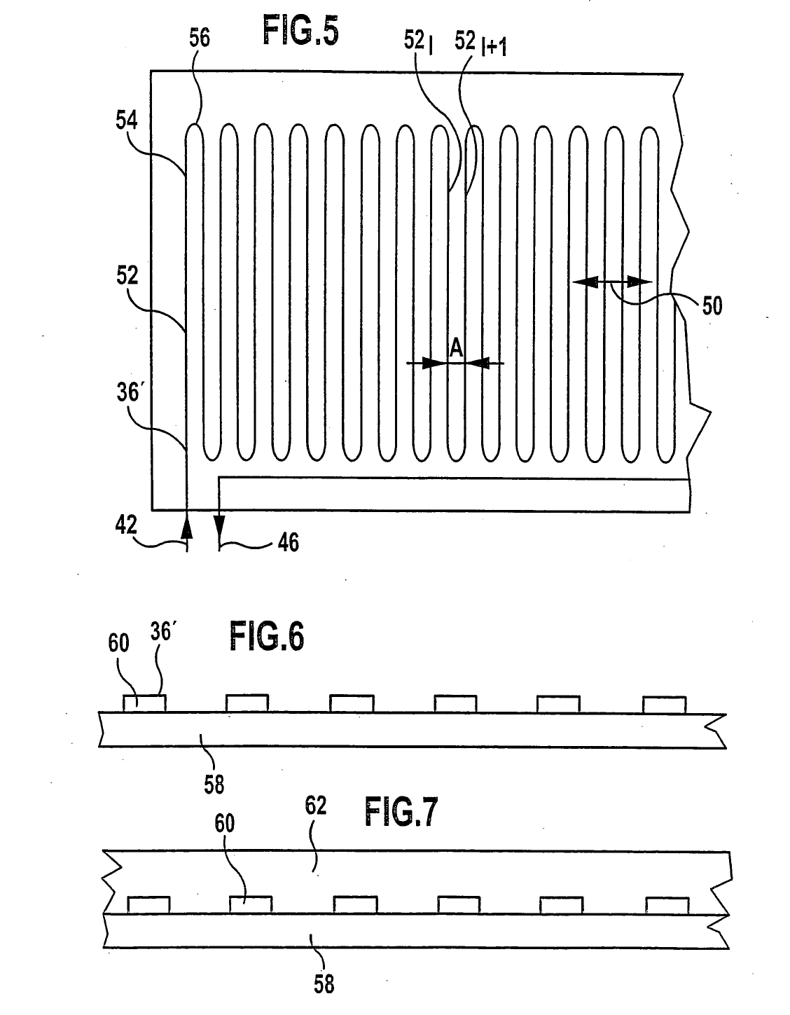

FIG. 5 shows a representation of a detector element in a developed projection of the second exemplary embodiment;

FIG. 6 shows a section along line 6-6 in FIG. 5;

FIG. 7 shows a section through a third exemplary embodiment of a line arrangement according to the invention;

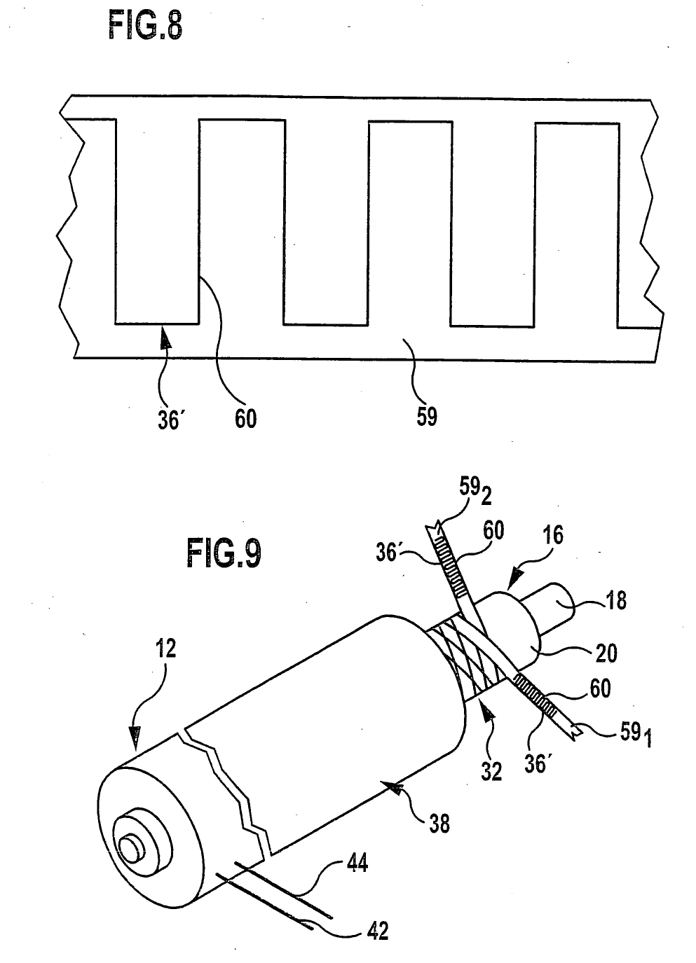

FIG. 8 shows a representation of a detector element of a fourth exemplary embodiment;

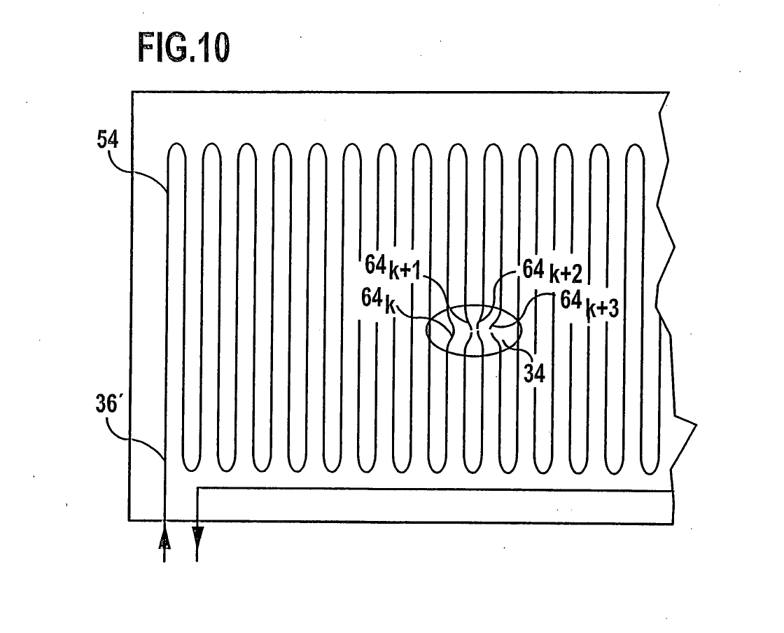

FIG. 9 shows a representation of a line strand in the case of the fourth exemplary embodiment;

FIG. 10 shows a representation similar to FIG. 4 of a fifth exemplary embodiment with a representation of the effects of an arc;

FIG. 11 shows a representation similar to FIG. 1 of a sixth exemplary embodiment of the line arrangement according to the invention;

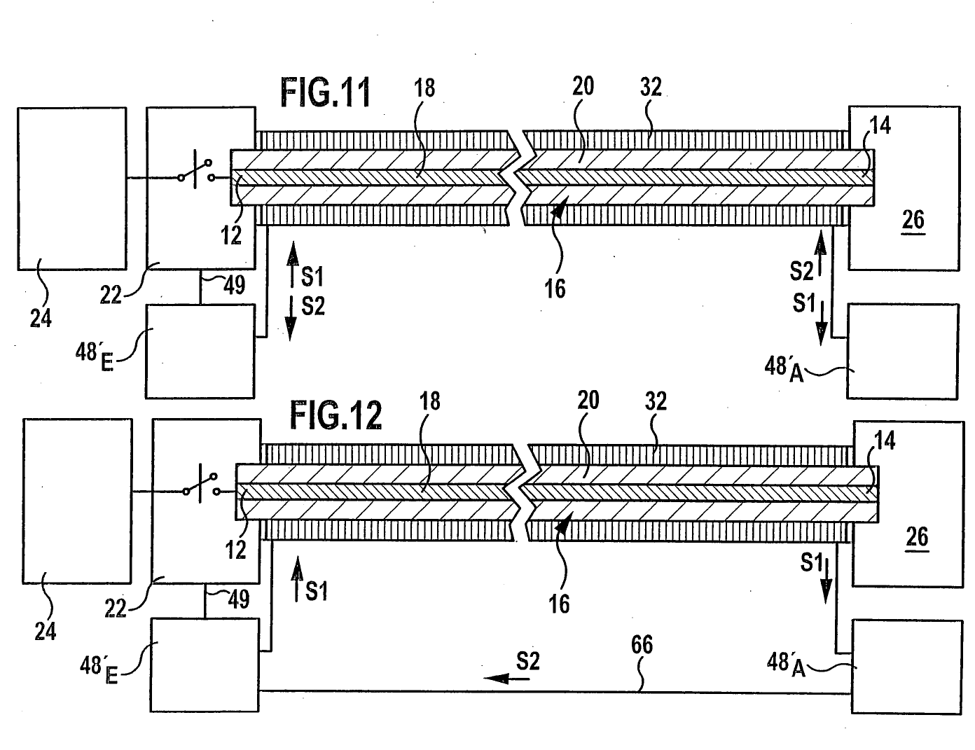

FIG. 12 shows a representation similar to FIG. 1 of a seventh exemplary embodiment of the line arrangement according to the invention;

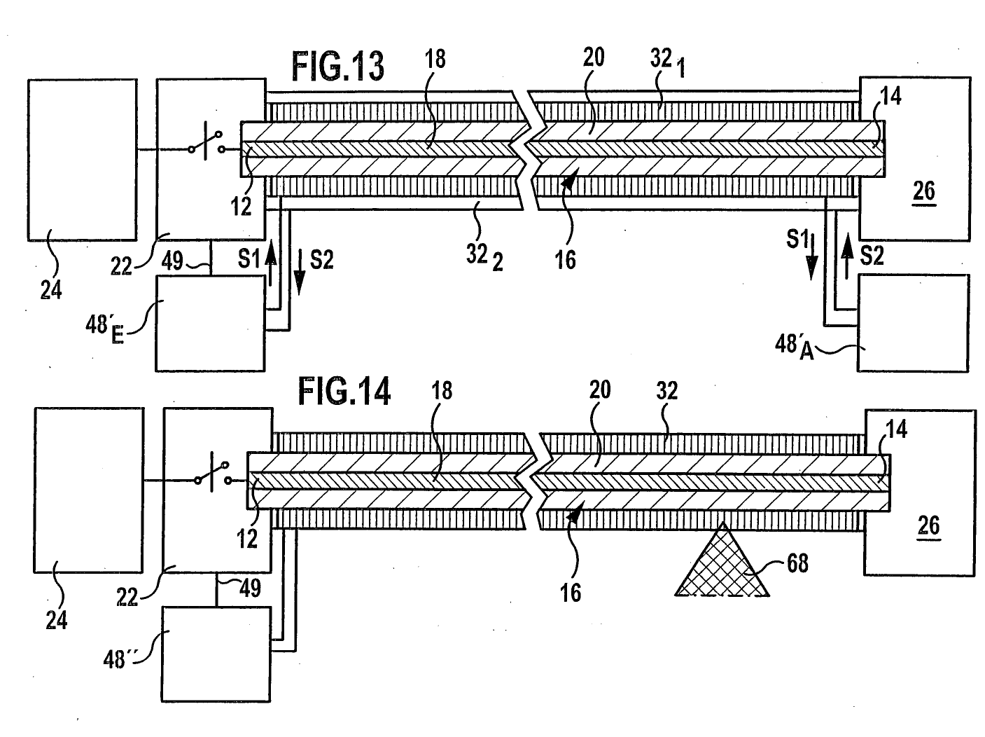

FIG. 13 shows a representation similar to FIG. 1 of an eighth exemplary embodiment of the line arrangement according to the invention;

FIG. 14 shows a representation similar to FIG. 1 of a ninth exemplary embodiment of the line arrangement according to the invention;

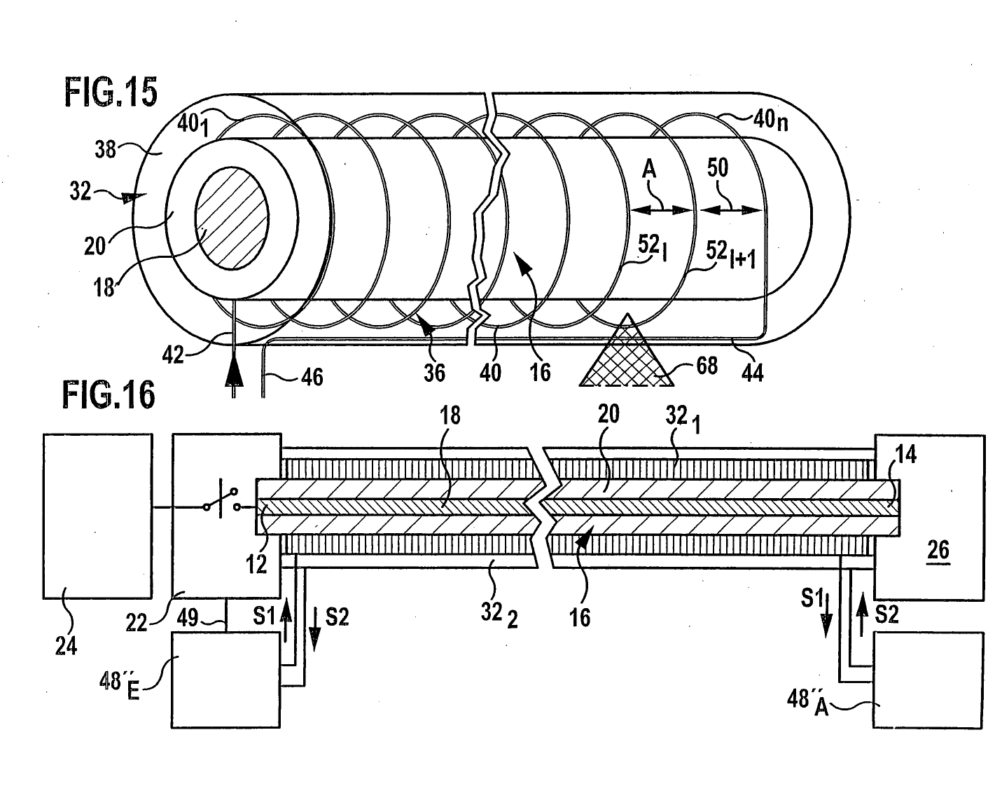

FIG. 15 shows a representation similar to FIG. 3 of the ninth exemplary embodiment of the line arrangement according to the invention and

FIG. 16 shows a representation similar to FIG. 1 of a tenth exemplary embodiment of the line arrangement according to the invention.

A first exemplary embodiment of a line arrangement according to the invention, in particular for electrical systems of vehicles, preferably of motor vehicles, comprises a line strand, designated as a whole by 10, with an electrical supply line 16 running from a current feed terminal 12 to a current delivery terminal 14 and having at least one current-carrying inner conductor 18 and at least one protective sheath 20 surrounding this inner conductor 18.

The current feed terminal 12 is in this case connected to an isolating circuit, which is designated as a whole by 22, is provided between a current source 24 and the current feed terminal 12 and is capable of quickly de-energizing the supply line 16.

The current source 24 preferably operates at a voltage of more than 40 volts, for example approximately 42 volts direct current, so that the inner conductor 18 of the supply line 16 is also at this voltage when a load 26 connected to the current delivery terminal 14, for example a unit of the vehicle, is to be operated by means of the supply line 16.

If in this case the the line strand 10 is defective, for example due to hairline cracks in the sheath of the line strand 10 into which moisture has penetrated, a local arc 28, known as a parallel arc, may form at the defective point and lead from the inner conductor 18 for example to a body component 30 of the vehicle which is normally grounded with respect to the inner conductor 18; this case is referred to as the first case of a defect and is represented in FIG. 1.

A second case of a defect is represented in FIG. 2. In this case, the inner conductor 18 is ruptured. When current flows via the damaged inner conductor 18, a local arc 28′, known as a series arc, forms at this point and leads from one end of the rupture of the inner conductor 18 to the opposite end of the rupture of the inner conductor 18 if the ends of the rupture are still in direct proximity or loosely touching.

Such an arc 28 or 28′, which can occur in particular at voltages of greater than 20 volts, can lead very quickly to burning of the protective sheath 20 of the supply line 16 or damage to other parts of the vehicle.

For this reason, the line arrangement 10 comprises a detector element 32, which extends substantially from the current feed terminal 12 to the current delivery terminal 14 and also encloses the supply line 16.

The detector element 32 is in this case formed in such a way that, when an arc 28 or 28′ which passes through the detector element 32 in a region 34 or spreads within the same occurs, it changes in its electrical and/or optical conductivity locally in this region 34.

For this purpose, as represented in FIG. 3, the detector element 32 comprises for example a detector line 36, which is embedded together with the supply line 16 in a protective enclosure 38 and with successive windings 40 helically surrounds the supply line 16 over its extent from the current feed terminal 12 to the current delivery terminal 14.

In this case, a first connecting piece 42 of the detector line 36, running for example to the first winding 40₁, is led out from the detector element 32 and a return line 44 of said detector line runs from the last winding 40ₙ through the protective enclosure 38 and, like the first connecting piece 42, is led out from the detector element 32 close to the current feed terminal 12 as the second connecting piece 46.

As represented in FIG. 1, these two connecting pieces 42 and 44 are preferably connected to a detector circuit 48, which is capable when the arc 28 occurs of activating the isolating circuit 22 via an electrical or optical line 49 in such a way that said isolating circuit interrupts the connection between the current feed terminal 12 and the current source 24.

In order that the formation of the arc 28 or 28′ can be sensed by means of the detector line 36 in every region of the supply line 16, the detector line 36 is laid in such a way that successive portions 52_{I} and 52_{I+1} of the detector line 36 running transversely in relation to a longitudinal direction 50 of the supply line 16 are spaced apart from one another by a spacing A which is less than the extent of an arc 28 or 28′ normally occurring, preferably less than approximately the diameter of the inner conductor 18.

Furthermore, the detector line 36 is formed from a material which changes in its electrical or optical behavior when the arc 28 or 28′ occurs.

If the detector line 36 is formed for example as an electrically conductive line, one possibility envisages giving this electrical line the form of a metal wire, such a metal wire being produced from metals of the group of eutectics, to which materials such as soldering tin also belong. In the case of such eutectics, the temperature from which an irreversible thermal destruction of the line takes place at a specific point, for example due to fusing, can be set in a simple way by means of the material composition of the same.

When metals are used, the material composition is preferably to be chosen such that they melt from temperatures in the range from approximately 100° C. to approximately 500° C., still better more than 300° C., so that, when an arc 28 or 28′ forms, the portion 52 of the detector line 36 running in the region 34 through which the arc 28 or 28′ passes is heated to such an extent that it melts locally and consequently the electrical behavior, for example the electrical conductivity, of the detector line 36 is changed. In the simplest case, an irreversible interruption of the detector line 36 takes place by local fusing of the same in the region 34.

However, instead of a metal wire it is also conceivable to use as the detector line 36 an electrically conductive plastic or polymer fiber, which thermally degrades irreversibly, and consequently likewise changes, in particular becomes inferior, at least in its electrical conductivity, when an arc 28 or 28′ forms.

In all cases, by applying a voltage to the connecting pieces 42 and 46, the detector circuit 48 is capable of checking the electrical behavior of the detector line 36 and sensing changes, in particular deteriorations, of the electrical conductivity, which are an indication of the occurrence of an arc 28 or 28′. In these cases, the detector circuit 48 makes the isolating circuit 22 isolate the current feed terminal 12 from the current source 24.

As an alternative to the provision of an electrical conductor, there is, however, also the possibility of forming the detector line 36 as an optical line, in particular as a light guide.

Such a light guide is preferably a polymer light guide which is produced from a polymer with an optical transmission which deteriorates significantly when a temperature threshold is exceeded, for example from a temperature in the range from approximately 100° C. to approximately 500° C.

The occurrence of an arc 28 or 28′ would then likewise lead to the transmission of the detector line 36 being irreversibly reduced in the portion 52 passing through the region 34, inevitably resulting in a reduction in the transmission of the overall detector line 36.

The detector circuit 48 is consequently capable, by feeding light into one of the connecting pieces 42 or 46 and detection of light at the other connecting piece 46 or 42, respectively, of sensing the optical transmission of the detector line 36 and registering changes which are an indication of the formation of an arc 28 or 28′. In these cases, the detector circuit 48 brings about isolation of the current feed terminal 12 from the current source 24 by suitable activation of the isolating circuit 22.

Irrespective of the material of the detector line 36, it is required that the detector element is unaffected by water, microbiologically resistant, flame-retardant, light-resistant, vibration-proof and resistant to reagents and cleaning agents, in particular gasoline, diesel, battery acid, brake fluid, conserving agents, cleaning agents or oil, in each case at the highest operating temperature.

In the case of a second exemplary embodiment of the detector element 32′ according to the invention, represented in FIGS. 3, 4 and 5, the detector line 36′ does not run around the supply line 16 in a helical manner, but instead in the form of meanders 54, which follow one another in the longitudinal direction 50 of the supply line 16, substantially enclose the supply line 16 in an azimuthal manner and—as represented in a developed projection in FIG. 4—lie next to one another in the longitudinal direction 50, the successive portions 52_{I} and 52_{I+1} that are running transversely in relation to the longitudinal direction 50 likewise being spaced apart from one another by a spacing A which is less than the extent of an arc 28 normally occurring, preferably less than approximately the diameter of the inner conductor 18.

Furthermore, arcuate segments 56 of the meanders 54 are likewise spaced apart from one another in the azimuthal direction in relation to the supply line 16 by a spacing B which is less than the extent of the arc 28 normally occurring, in particular less than approximately the diameter of the inner conductor 18.

Such a detector line 36′, given the form of successive meanders 54, can, as represented in FIG. 5, preferably be produced by tracks 60 forming the detector line 36′ being applied to a carrier 58, for example in the form of electrically conductive tracks either of a metal, in particular of a metal from the group of eutectics, or of an electrically conductive plastic or polymer.

Such an application of the tracks 60 to the carrier 58 may be performed by known mask or sputtering techniques with the carrier 58 spread out over a surface area, so that, after the tracks 60 have been applied, the carrier can be wound around the at least one supply line 16.

In the case of a third, preferred exemplary embodiment, represented in FIG. 6, there is also the possibility of protecting the tracks 60 applied to the carrier 58 by a covering layer 62, which may be applied as a film, or for example in a liquid state of aggregation, to the carrier 58 provided with the tracks 60.

It is also possible in principle in the case of the third exemplary embodiment for the detector line 36′ to be given the form of an electrical line or an optical line, its behavior in any event undergoing irreversible changes when the arc 28 occurs, in order to be able to sense this by means of the detector circuit 48.

In the case of a fourth exemplary embodiment, which is based on the principle of the third exemplary embodiment, for the forming of the detector line 36′, the tracks 60 are applied to a carrier strip 59 and, in the same way as in the case of the third exemplary embodiment, covered by a covering layer 62 in the width of the carrier strip 59.

For the forming of the detector element 32, two carrier strips 59₁ and 59₂ are then wound crosswise, that is to say with opposite winding directions, onto the protective sheath 20 of the inner conductor 18 and, in the same way as also in the case of the first exemplary embodiment, embedded together with the supply line 16 in the protective enclosure 38.

The detector lines 36′ of the carrier strips 59₁ and 59₂ are in this case respectively connected to one of the connecting pieces 42 or 44 on the side of the current feed terminal 12 and the detector lines 36′ are connected directly to each other in the region of the current delivery terminal 14, so that the detector lines 36′ provided on the carrier strips 59₁ and 59₂ are connected in series one behind the other between the connecting pieces 42 and 44 and it is also possible to dispense with the return line 44, since one of the detector lines 36′ itself forms the return line.

With such detector lines 36′ disposed on the carrier strips 59₁ and 59₂, on the one hand optimal covering of the supply line 16 and on the other hand optimal suitability for the production of a line strand 10 according to the invention can be achieved.

In the same way as in the case of the previous exemplary embodiments, the detector lines 36′ may be both electrical lines and optical lines.

In the case of a fifth exemplary embodiment, which is based on the basic principle of the second exemplary embodiment, the carrier 58, as represented in FIG. 10, is produced from a material which changes greatly in its shape, for example contracts, when the arc 28 occurs within the region 34, and that has the effect that portions 64ₖ to 64ₖ₊₃ of the detector line 36 that are lying within the region 34 undergo such great mechanical stresses as a result of the change in shape of the carrier 58 that the detector line 36 changes greatly in its electrical or optical behavior in these portions 64, in an extreme case tears, which irreversibly changes in particular the electrical or optical behavior of the detector line 36′.

In the case of a sixth exemplary embodiment, represented in FIG. 11,—as an alternative to the simplest and lowest-cost exemplary embodiments with only one detector circuit 48—both the current feed terminal 12 and the current delivery terminal 14 of the supply line 16 each have an associated detector circuit 48′_{E} and 48′_{A}, respectively, the detector circuits 48′_{E} and 48′_{A} communicating with each other.

Consequently, it is provided for example that, as represented in FIG. 11, the detector circuit 48′_{E} sends a detector signal S1 from the current feed terminal 12 to the current delivery terminal 14 via the detector element 32, which the detector circuit 48′_{A} receives and then for its part generates a detector signal S2 sends via the detector element 32, so that it is received by the detector circuit 48′_{E}.

If the electrical and/or optical behavior of the detector element 32 is irreversibly changed, in particular is faulty, the detector circuit 48′_{A} already does not receive the detector signal S1 with the intended quality, or does not receive it at all, and for its part does not generate a detector signal S2, so that the detector circuit 48′_{E} does not receive a detector signal S2 and detects from this the occurrence of the arc 28 and consequently makes the isolating circuit 22 isolate the current feed terminal 12 from the current source 24.

The emitted signals S1 and S2 may in this case be electrical or optical detector signals, so that the detector line 36, transmitting the signal S1, of the detector element 32 may represent an electrical line or an optical line and, irrespective of this, the return line 44 transmitting the signal S2, which however may also be a further detector line 36, as for example in the case of the fourth exemplary embodiment, may likewise be an electrical or optical line.

In the case of the seventh exemplary embodiment, represented in FIG. 12, as an alternative to the sending back of the detector signal S2 via the detector element 32, an additional line 66, running externally outside the line strand 10, may be provided, via which line the detector circuit 48′_{A} sends the detector signal S2 back to the detector circuit 48′_{E}.

This additional line 66 may be an additional line provided in the line arrangement, but also a line running separately from the latter, for example an electrical or optical data bus, which is present in any case in a vehicle.

In the case of an eighth exemplary embodiment, represented in FIG. 13, two detector elements 32₁ and 32₂ are provided in the line strand 10, with for example the detector signal S1 being sent from the detector circuit 48′_{E} to the detector circuit 48′_{A} via the detector element 32₁, while the detector signal S2 is sent from the detector circuit 48′_{A} to the detector circuit 48′_{E} via the detector element 32₂.

In this case, the detector elements 32₁ and 32₂ may respectively enclose only a subregion of the supply line 16 in the azimuthal direction and supplement each other overall to the extent that the supply line 16 is completely covered, as for example in the case of the fourth exemplary embodiment, or the detector elements 32₁ and 32₂ form overall a redundant system, and both enclose the supply line 16 substantially completely.

In the case of the eighth exemplary embodiment, there is the possibility of forming both detector elements 32₁ and 32₂ in such a way that they have a detector line 36 which in the case of both is an electrical line or in the case of both is an optical line.

There is, however, also the possibility of forming the detector line 36 of one detector element, for example the detector element 32₁, as an optical line and forming the detector line 36 of the detector element 32₂ as an electrical line, so that the detector elements 32₁ and 32₂ can be formed in such a way that the occurrence of the arc 28 leads at least in one of them to a change of the electrical behavior and leads in the other of them to a change of the optical behavior.

In the case of a ninth exemplary embodiment of a line arrangement according to the invention, represented in FIG. 14, it is possible as an addition to the exemplary embodiments described so far for the detector circuit 48″ to be modified in such a way that it detects not only a change in the electrical and/or optical capability of allowing detector signals to pass through it but also in addition a change of an electrical potential of the detector element 32.

If, for example, the detector element 32 is damaged by a body component 68, then, as illustrated once again in FIG. 15, an electrical contact is produced between the body component 68 and the detector line 36, the fact that the body component 68 is for example grounded having the effect that the detector line 36 also changes in its potential in such a way that it lies at a potential close to ground, this potential depending on the transition resistance between the detector line 36 and the body component 68.

If the detector circuit 48″ is then formed in such a way that it not only checks the electrical conductivity of the detector element 32 but also its potential with respect to ground, the detector circuit 48″ detects the damage to the detector element 32 and will consequently likewise make the isolating circuit 22 isolate the current feed terminal 12 from the current source 24.

Such a potential detection can also be realized in the case of a tenth exemplary embodiment, as represented in FIG. 16, when both the current feed terminal 12 and the current delivery terminal 14 respectively have an associated detector circuit 48″, that is to say the detector circuit 48″_{E} and the detector circuit 48″_{A}. If both detector circuits 48″_{E} and 48″_{A} also detect a change of the potential of the respective detector element 32₁ or 32₂, mechanical damage, for example caused by the grounded body component 68, can also be detected and, on this basis, the current feed terminal 12 can be isolated from the current source 24 by the isolating circuit 22.

In the case of this solution, the combination of optically operating and electrically operating detector elements 32 can be realized particularly advantageously, so that for example the detector element 32₁ responds to an arc by changing the optical behavior, while the detector element 32₂ responds to an arc by changing its electrical behavior. At the same time, it is also detected by the detector circuit 48″ if the detector element 32₂ changes its electrical potential on account of the effect of the body component 68.

In addition, in the case of the embodiment of the detector elements 32 according to the invention and irrespective of their operating mode, there is always the possibility of establishing when there are major mechanical effects on the line strand 10, in particular the detector elements 32, by these mechanical effects also leading in every case to damage of the detector line 36 and consequently to changing of its electrical and/or optical behavior.

1-39. (cancelled).

40. A line arrangement for electrical systems of vehicles, comprising:
an electrical supply line running from a current feed terminal to a current delivery terminal and having at least one current-carrying inner conductor and at least one protective sheath surrounding the inner conductor,
a detector element which runs along the supply line and is formed in such a way that its electrical and/or optical behavior is irreversibly changed when a local arc originating from the current-carrying inner conductor occurs, and
an isolating circuit connected to the current feed terminal to isolate the current-carrying inner conductor from a current source when the electrical and/or optical behavior of the detector element changes.

41. A line arrangement according to claim 40, wherein the detector element is formed in such a way that it irreversibly deteriorates in its electrical and/or optical behavior under the local effect of heat.

42. A line arrangement according to claim 40, wherein the detector element surrounds the supply line.

43. A line arrangement according to claim 40, wherein the detector element comprises at least one electrical and/or optical detector line, the electrical and/or optical behavior of which is irreversibly changed when the arc occurs.

44. A line arrangement according to claim 43, wherein the detector line runs in the form of a helix.

45. A line arrangement according to claim 43, wherein the detector line runs in the form of meanders.

46. A line arrangement according to claim 43, wherein portions of the detector line following one another in a longitudinal direction of the supply line and running transversely in relation to the longitudinal direction of the supply line are spaced apart from one another by a spacing which is less than approximately the diameter of the inner conductor.

47. A line arrangement according to claim 43, wherein the detector line consists of a material which irreversibly changes in its electrical and/or optical behavior when there is local ingress of an amount of heat that can be generated by the arc.

48. A line arrangement according to claim 43, wherein the detector line consists of a material which irreversibly changes in its electrical and/or optical behavior from a threshold temperature, which lies in the range from approximately 100° C. to approximately 500° C.

49. A line arrangement according to claim 43, wherein the detector line is surrounded by an insulating protective enclosure.

50. A line arrangement according to claim 40, wherein the detector element has a carrier on which the detector line is held.

51. A line arrangement according to claim 50, wherein the detector line is disposed in the form of conducting tracks on the carrier.

52. A line arrangement according to claim 51, wherein the conducting tracks run in the manner of meanders on the carrier.

53. A line arrangement according to claim 51, wherein the carrier is given the form of a carrier strip.

54. A line arrangement according to claim 53, wherein the carrier strip runs helically around the supply line.

55. A line arrangement according to claim 50, wherein the carrier surrounds the supply line at least partially.

56. A line arrangement according to claim 50, wherein the carrier encloses the supply line substantially completely.

57. A line arrangement according to claim 50, wherein the carrier forms part of a protective enclosure for the detector line.

58. A line arrangement according to claim 50, wherein the carrier consists of a material which irreversibly changes under the effect of the arc originating from the inner conductor.

59. A line arrangement according to claim 58, wherein the carrier consists of a material which irreversibly deforms under the effect of the arc originating from the inner conductor.

60. A line arrangement according to claim 58, wherein the carrier consists of a material which irreversibly decomposes under the effect of the arc originating from the inner conductor.

61. A line arrangement according to claim 58, wherein on account of its irreversible change under the local effect of the arc, the carrier irreversibly changes the electrical and/or optical behavior of the detector line.

62. A line arrangement according to claim 61, wherein the carrier locally interrupts the detector line.

63. A line arrangement according to claim 40, wherein the detector element irreversibly changes in its electrical and/or optical behavior when it is mechanically damaged.

64. A line arrangement according to claim 40, wherein the detector element changes in its electrical and/or optical behavior when it undergoes mechanical damage caused by a mechanical component at a potential other than that of the detector line.

65. A line arrangement according to claim 63, wherein the detector line irreversibly changes in its electrical and/or optical behavior when the detector element undergoes mechanical damage.

66. A line arrangement according to claim 65, wherein the detector line irreversibly deteriorates in its behavior with regard to the passing through of electrical and/or optical signals when it undergoes mechanical damage.

67. A line arrangement according to claim 40, wherein the detector line lies in a circuit specific to the detector line.

68. A line arrangement according to claim 40, wherein at least one detector circuit is provided which activates the isolating circuit.

69. A line arrangement according to claim 68, wherein the detector circuit is associated with the current feed terminal.

70. A line arrangement according to claim 68, wherein the detector circuit is associated with the current delivery terminal.

71. A line arrangement according to claim 68, wherein the detector circuit communicates with the isolating circuit by means of an electrical line.

72. A line arrangement according to claim 68, wherein the detector circuit communicates with the isolating circuit by means of a light guide.

73. A line arrangement according to claim 68, wherein:
a number of detector circuits are provided, and
the detector circuits communicate with one another to sense a change of the electrical and/or optical behavior of the detector element.

74. A line arrangement according to claim 73, wherein the detector circuits communicate with one another via an internal line within the line strand.

75. A line arrangement according to claim 73, wherein the detector circuits communicate with one another via an external line outside the line strand.

76. A line arrangement according to claim 73, wherein the detector circuits communicate with one another via an electrical line.

77. A line arrangement according to claim 73, wherein the detector circuits communicate with one another via an optical line.

78. A line arrangement according to claim 68, wherein the detector circuit detects the occurrence of a potential in the detector line other than that of the detector line.
